(19) United States
(12) Patent Application Publication
(10) Pub. No.: US 2021/0363353 A1
(43) Pub. Date: Nov. 25, 2021

(54) Method for Improving Alkali Resistance and Oxidation Resistance of Benzisothiazole Disperse Dye

(71) Applicants: Qingdao University, Qingdao (CN); Penglai Jiaxin Dye Chemical Co., LTD, Penglai (CN)

(72) Inventors: Changhai XU, Qingdao (CN); Xiaoyan WANG, Qingdao (CN); Liang HE, Penglai (CN); Mingtao QIU, Penglai (CN); Xinting ZHAO, Penglai (CN); Jinmei DU, Qingdao (CN); Jinglin TANG, Penglai (CN)

(21) Appl. No.: 17/392,478

(22) Filed: Aug. 3, 2021

(30) Foreign Application Priority Data
Aug. 27, 2020 (CN) 2020108775846

(51) Int. Cl. C09B 29/033

(52) U.S. Cl. CPC C09B 29/0081

(57) ABSTRACT

The disclosure relates to a method for improving the alkali resistance and oxidation resistance of a benzisothiazole disperse dye, and belongs to the technical field of textiles. In the disclosure, azo alkali-resistant disperse dyes with benzisothiazole as a diazo component are synthesized based on structural design of the dyes, the alkali resistance and oxygen bleaching resistance of the heterocyclic azo disperse dyes are improved by introducing different groups to a coupling component, a series of benzisothiazole disperse dyes having gradient differences in alkali resistance and oxidation resistance are obtained, disperse dyes capable of meeting requirements of a one-bath process for cotton bleaching and disperse dyeing of a polyester-cotton blended fabric or a one-bath process for alkali deweighting and disperse dyeing of polyester fabrics are determined, and a reference can be provided for structural design of disperse dyes with alkali resistance and oxidation resistance.

### TECHNICAL FIELD

The disclosure relates to a method for improving the alkali resistance and oxidation resistance of a benzisothiazole disperse dye, and belongs to the technical field of textiles.

### BACKGROUND

A polyester-cotton blended fabric has moisture absorption performance of cotton fibers, good rubbing resistance of polyester fibers, ironing-free performance and quick-drying performance, is deeply loved by consumers and has an important position in garment fabrics. However, since the polyester-cotton blended fabric consists of two fibers with different properties, dyeing and finishing need to be performed on two types of fibers during processing and are generally performed in multiple steps. Generally speaking, pretreatment such as refining and bleaching needs to be performed on the polyester-cotton blended fabric under an alkali condition, processes such as washing, acid pickling and washing need to be performed after bleaching to make preparation for acidic dyeing with a disperse dye, and acetic acid needs to be added to adjust the pH before the disperse dye is added. The entire process consumes a long time and is cumbersome, the consumption of water and energy is high, a large amount of sewage is discharged, and the environment is polluted.

In order to reduce the process flow, shorten the processing time and improve the production efficiency, a one-bath process for cotton bleaching and disperse dyeing of a polyester-cotton blended fabric has been proposed in recent years, but the selectivity for disperse dyes in this process is high, and the disperse dyes are required to have high alkali resistance and oxidation resistance.

### SUMMARY

In order to solve at least one problem above, the disclosure provides a method for improving the alkali resistance and oxidation resistance of a benzisothiazole disperse dye.

In the disclosure, benzisothiazole is used as a diazo component, aniline derivatives are used as a coupling component, a series of disperse dyes are designed and synthesized by adjusting groups on the diazo component, and the alkali resistance and oxidation resistance of this kind of disperse dyes are improved; the alkali resistance, oxidation resistance and other dyeing properties of the synthetic disperse dyes are tested; a series of benzisothiazole disperse dyes having gradient differences in alkali resistance and oxidation resistance are obtained by introducing different substituents, disperse dyes capable of meeting requirements of a one-bath process for cotton bleaching and disperse dyeing of a polyester-cotton blended fabric or a one-bath process for alkali deweighting and disperse dyeing of polyester fabrics are determined, and a reference is provided for structural design of disperse dyes with alkali resistance and oxidation resistance.

A first objective of the disclosure is to provide a method for preparing benzisothiazole disperse dyes different in alkali resistance, a difference in alkali resistance is achieved by adjusting groups of a structural formula of the benzisothiazole disperse dyes, and an alkali resistance sequence of the disperse dyes is obtained after different groups are introduced, wherein the structural formula of the benzisothiazole disperse dyes is shown in Formula 1:

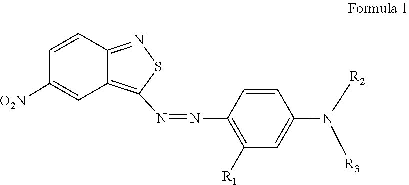

and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; alkyl groups involved are all C1-4 alkyl groups;

on the basis that R₁ is hydrogen, methyl, ethyl, methoxy or ethoxy and R₂ is linear or branched alkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl>the alkali resistance of a benzisothiazole disperse dye obtained when R₃ is cyanoalkyl, cyanoalkoxyalkyl or hydroxyalkyl;

on the basis that R₁ is hydrogen, methyl, ethyl, methoxy or ethoxy and R₂ is cyanoalkyl or cyanoalkoxyalkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl.

In an embodiment of the disclosure, on the basis that R₁ is hydrogen, methyl or ethyl and R₂ is linear or branched alkyl, the alkali resistance of a benzisothiazole disperse dye obtained when R₃ is benzyl or alkylbenzyl>the alkali resistance of a benzisothiazole disperse dye obtained when R₃ is alkyl>the alkali resistance of a benzisothiazole disperse dye obtained when R₃ is cyanoalkyl, cyanoalkoxyalkyl or hydroxyalkyl.

In an embodiment of the disclosure, on the basis that R₁ is hydrogen, methyl or ethyl and R₂ is cyanoalkyl or cyanoalkoxyalkyl, the alkali resistance of a benzisothiazole disperse dye obtained when R₃ is benzyl or alkylbenzyl is higher than that>the alkali resistance of a benzisothiazole disperse dye obtained when R₃ is alkyl.

In an embodiment of the disclosure, on the basis that R₁ is H, CH₃ or CH₂CH₃ and R₂ is CH₂CH₃, the alkali resistance of a benzisothiazole disperse dye obtained when R₃ is

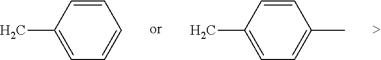

the alkali resistance of a benzisothiazole disperse dye obtained when R₃ is CH₂CH₃>the alkali resistance of a benzisothiazole disperse dye obtained when R₃ is CH₂CH₂CN, CH₂CH₂OCH₂CH₂CN or CH₂CH₂OH.

In an embodiment of the disclosure, on the basis that R₁ is H, CH₃ or CH₂CH₃ and R₂ is CH₂CH₂CN or CH₂CH₂OCH₂CH₂CN, the alkali resistance of a benzisothiazole disperse dye obtained when R₃ is

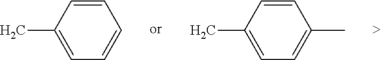

the alkali resistance of a benzisothiazole disperse dye obtained when R₃ is CH₂CH₃.

In an embodiment of the disclosure, a synthetic method of a benzisothiazole disperse dye includes the following steps:

(1) obtaining a diazo solution through a diazotization reaction;

(2) performing a coupling reaction: making the diazo solution and a coupling component undergo a reaction to obtain a product filter cake;

(3) performing purification: performing recrystallization to purify a dye.

In an embodiment of the disclosure, a synthetic method of a benzisothiazole disperse dye includes the following steps:

(1) performing a diazo reaction: adding 3-amino-5-nitrobenzisothiazole into a single-neck flask, adding concentrated H₂SO₄, reducing the temperature to 0-5° C., adding nitrosyl sulfuric acid under stirring, performing uniform stirring and detection with a starch-potassium iodide test paper until the color is blue to ensure that nitrosyl sulfuric acid is excessive, performing a reaction continuously for 2-5 h, adding sulfamic acid to remove excessive nitrosyl sulfuric acid after the reaction is completed, and performing stirring for 15 min to obtain a diazo solution;

(2) performing a coupling reaction: adding water, H₂SO₄ and a coupling component into a double-neck flask, performing stirring, and reducing the temperature to 0-10° C. for a reaction to obtain a coupling solution; slowly adding the diazo solution obtained in step (1) dropwise into the coupling solution under stirring for performing a reaction continuously at 0-10° C. for 1-3 h, increasing the temperature to 0-15° C. for performing a reaction continuously for 4-5 h, and after the reaction is completed, adding sodium hydroxide to adjust the pH to neutral to obtain a product; performing suction filtration, washing and drying on the obtained product to obtain a filter cake;

(3) dissolving the filter cake obtained in step (2) in an ethanol solution, and performing reflux at 70° C. for 2 h, cooling, recrystallization, filtration and drying to obtain a benzisothiazole disperse dye.

In an embodiment of the disclosure, a method for preparing benzisothiazole disperse dyes different in alkali resistance includes adjusting an N substituent in the coupling component (namely, an aniline derivative) to achieve a difference in alkali resistance, and the alkali resistance of a benzisothiazole disperse dye obtained when the N substituent in the coupling component is p-methylbenzyl or benzyl>the alkali resistance of a benzisothiazole disperse dye obtained when the N substituent in the coupling component is benzyl+cyano or benzyl+cyanoethoxyethyl>the alkali resistance of a benzisothiazole disperse dye obtained when the N substituent in the coupling component is ethyl>the alkali resistance of a benzisothiazole disperse dye obtained when the N substituent in the coupling component is cyanoethyl, cyanoethoxyethyl or hydroxyethyl.

In an embodiment of the disclosure, the coupling component in step (2) is N,N-diethylaniline, N,N-diethyl-m-toluidine, N,N-diethyl-m-ethylaniline, N-ethyl-N-hydroxyethylaniline, N-ethyl-N-hydroxyethyl-m-toluidine, N-ethyl-N-hydroxyethyl-m-ethylaniline, N,N-dihydroxyethylaniline, N,N-dihydroxyethyl-m-toluidine, N-ethyl-N-cyanoethylaniline, N-ethyl-N-cyanoethyl-m-toluidine, N-ethyl-N-cyanoethyl-m-ethylaniline, N-cyanoethyl-N-benzylaniline, N-cyanoethyl-N-benzyl-m-toluidine, N-ethyl-N-cyanoethoxyethylaniline, N-cyanoethoxyethyl-N-benzyl-m-toluidine, N-cyanoethoxyethyl-N-benzyl-m-ethylaniline, N-ethyl-N-benzylaniline, N-ethyl-N-benzyl-m-toluidine, N-ethyl-N-benzyl-m-ethylaniline, N-ethyl-N-p-methylbenzylaniline, N-ethyl-N-p-methylbenzyl-m-toluidine or N-ethyl-N-p-methylbenzyl-m-ethylaniline.

A second objective of the disclosure is to provide a method for preparing benzisothiazole disperse dyes different in oxidation resistance when the pH=10, a difference in oxidation resistance is achieved by adjusting groups of a structural formula of the benzisothiazole disperse dyes, and an oxidation resistance sequence of the disperse dyes is obtained after groups are introduced, wherein the structural formula of the benzisothiazole disperse dyes is shown in Formula 1:

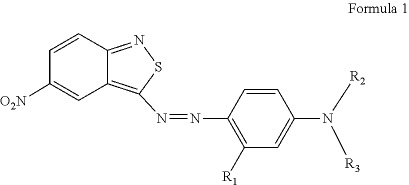

and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; alkyl groups involved are all C1-4 alkyl groups;

on the basis that R₁ is hydrogen, methyl, ethyl, methoxy or ethoxy and R₂ is linear or branched alkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is cyanoalkyl, cyanoalkoxyalkyl or hydroxyalkyl.

On the basis that R₁ is hydrogen, methyl, ethyl, methoxy or ethoxy and R₂ is cyanoalkyl or cyanoalkoxyalkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is alkyl.

In an embodiment of the disclosure, on the basis that R₁ is hydrogen, methyl or ethyl and R₂ is linear or branched alkyl, the oxidation resistance of a benzisothiazole disperse dye obtained when R₃ is benzyl, alkylbenzyl or alkyl>the oxidation resistance of a benzisothiazole disperse dye obtained when R₃ is cyanoalkyl, cyanoalkoxyalkyl or hydroxyalkyl.

In an embodiment of the disclosure, on the basis that R₁ is hydrogen, methyl or ethyl and R₂ is cyanoalkyl or cyanoalkoxyalkyl, the oxidation resistance of a benzisothiazole disperse dye obtained when R₃ is benzyl or alkylbenzyl>the oxidation resistance of a benzisothiazole disperse dye obtained when R₃ is alkyl.

In an embodiment of the disclosure, on the basis that R₁ is H, CH₃ or CH₂CH₃ and R₂ is CH₂CH₃, the oxidation resistance of a benzisothiazole disperse dye obtained when R₃ is

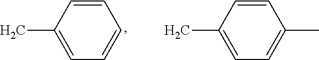

or CH₂CH₃>the oxidation resistance of a benzisothiazole disperse dye obtained when R₃ is CH₂CH₂OH, CH₂CH₂CN or CH₂CH₂OCH₂CH₂CN.

In an embodiment of the disclosure, on the basis that R₁ is H, CH₃ or CH₂CH₃ and R₂ is CH₂CH₂CN or CH₂CH₂OCH₂CH₂CN, the oxidation resistance of a benzisothiazole disperse dye obtained when R₃ is

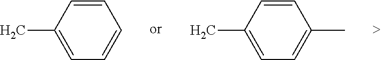

the oxidation resistance of a benzisothiazole disperse dye obtained when R₃ is CH₂CH₃.

In an embodiment of the disclosure, a synthetic method of a benzisothiazole disperse dye includes the following steps:

(1) obtaining a diazo solution through a diazotization reaction; (2) performing a coupling reaction: making the diazo solution and a coupling component undergo a reaction to obtain a product filter cake; (3) performing purification: performing recrystallization to purify a dye.

In an embodiment of the disclosure, a synthetic method of a benzisothiazole disperse dye includes the following steps:

(1) performing a diazo reaction: adding 3-amino-5-nitrobenzisothiazole into a single-neck flask, adding concentrated H₂SO₄, reducing the temperature to 0-5° C., adding nitrosyl sulfuric acid under stirring, performing uniform stirring and detection with a starch-potassium iodide test paper until the color is blue to ensure that nitrosyl sulfuric acid is excessive, performing a reaction continuously for 2-5 h, adding sulfamic acid to remove excessive nitrosyl sulfuric acid after the reaction is completed, and performing stirring for 15 min to obtain a diazo solution;

(2) performing a coupling reaction: adding water, H₂SO₄ and a coupling component into a double-neck flask, performing stirring, and reducing the temperature to 0-10° C. for a reaction to obtain a coupling solution; slowly adding the diazo solution obtained in step (1) dropwise into the coupling solution under stirring for performing a reaction continuously at 0-10° C. for 1-3 h, increasing the temperature to 0-15° C. for performing a reaction continuously for 4-5 h, and after the reaction is completed, adding sodium hydroxide to adjust the pH to neutral to obtain a product; performing suction filtration, washing and drying on the obtained product to obtain a filter cake;

(3) dissolving the filter cake obtained in step (2) in an ethanol solution, and performing reflux at 70° C. for 2 h, cooling, recrystallization, filtration and drying to obtain a benzisothiazole disperse dye.

In an embodiment of the disclosure, a method for preparing benzisothiazole disperse dyes different in oxidation resistance when the pH=10 includes adjusting an N substituent in the coupling component (namely, an aniline derivative) to achieve a difference in oxidation resistance, and the oxidation resistance of a benzisothiazole disperse dye obtained when the N substituent in the coupling component is p-methylbenzyl, benzyl, ethyl, benzyl+cyano or benzyl+cyanoethoxyethyl>the oxidation resistance of a benzisothiazole disperse dye obtained when the N substituent in the coupling component is cyanoethyl, cyanoethoxyethyl or hydroxyethyl.

In an embodiment of the disclosure, the coupling component in step (2) is N,N-diethylaniline, N,N-diethyl-m-toluidine, N,N-diethyl-m-ethylaniline, N-ethyl-N-hydroxyethylaniline, N-ethyl-N-hydroxyethyl-m-toluidine, N-ethyl-N-hydroxyethyl-m-ethylaniline, N,N-dihydroxyethylaniline, N,N-dihydroxyethyl-m-toluidine, N-ethyl-N-cyanoethylaniline, N-ethyl-N-cyanoethyl-m-toluidine, N-ethyl-N-cyanoethyl-m-ethylaniline, N-cyanoethyl-N-benzylaniline, N-cyanoethyl-N-benzyl-m-toluidine, N-ethyl-N-cyanoethoxyethylaniline, N-cyanoethoxyethyl-N-benzyl-m-toluidine, N-cyanoethoxyethyl-N-benzyl-m-ethylaniline, N-ethyl-N-benzylaniline, N-ethyl-N-benzyl-m-toluidine, N-ethyl-N-benzyl-m-ethylaniline, N-ethyl-N-p-methylbenzylaniline, N-ethyl-N-p-methylbenzyl-m-toluidine or N-ethyl-N-p-methylbenzyl-m-ethylaniline.

A third objective of the disclosure is to provide a benzisothiazole disperse dye with a structural formula shown in Formula 2,

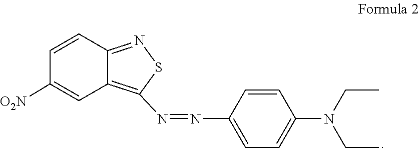 [SMILES: CCN(CC)c1ccc(N=Nc2snc3ccc([N+](=O)[O-])cc23)cc1]

A fourth objective of the disclosure is to provide a benzisothiazole disperse dye with a structural formula shown in Formula 3,

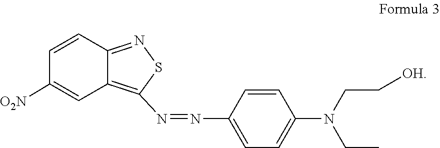 [SMILES: CCN(CCO)c1ccc(N=Nc2snc3ccc([N+](=O)[O-])cc23)cc1]

A fifth objective of the disclosure is to provide a benzisothiazole disperse dye with a structural formula shown in Formula 4,

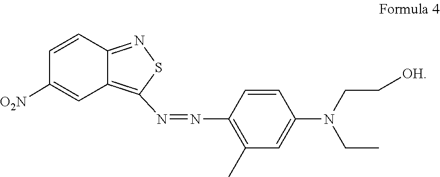 [SMILES: CCN(CCO)c1ccc(N=Nc2snc3ccc([N+](=O)[O-])cc23)c(C)c1]

A sixth objective of the disclosure is to provide a benzisothiazole disperse dye with a structural formula shown in Formula 5,

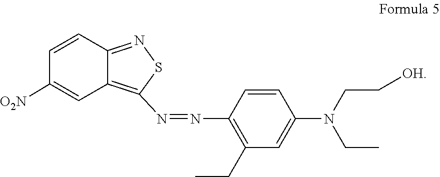 [SMILES: CCc1cc(N(CC)CCO)ccc1N=Nc1snc2ccc([N+](=O)[O-])cc12]

A seventh objective of the disclosure is to provide a benzisothiazole disperse dye with a structural formula shown in Formula 6,

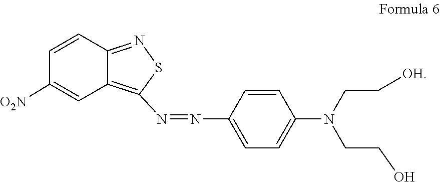 [SMILES: O=[N+]([O-])c1ccc2nsc(N=Nc3ccc(N(CCO)CCO)cc3)c2c1]

An eighth objective of the disclosure is to provide a benzisothiazole disperse dye with a structural formula shown in Formula 7,

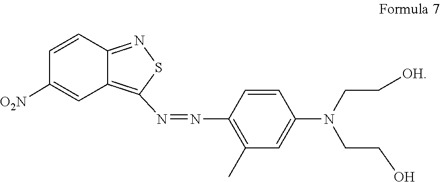 [SMILES: Cc1cc(N(CCO)CCO)ccc1N=Nc1snc2ccc([N+](=O)[O-])cc12]

A ninth objective of the disclosure is to provide a benzisothiazole disperse dye with a structural formula shown in Formula 8,

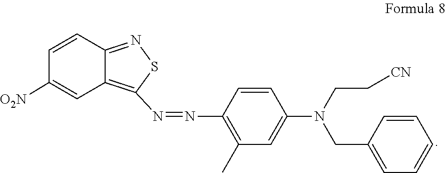 [SMILES: Cc1cc(N(CCC#N)Cc2ccccc2)ccc1N=Nc1snc2ccc([N+](=O)[O-])cc12]

A tenth objective of the disclosure is to provide a benzisothiazole disperse dye with a structural formula shown in Formula 9,

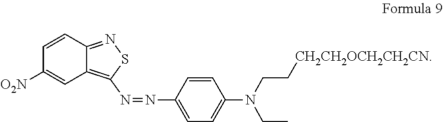

An eleventh objective of the disclosure is to provide a benzisothiazole disperse dye with a structural formula shown in Formula 10,

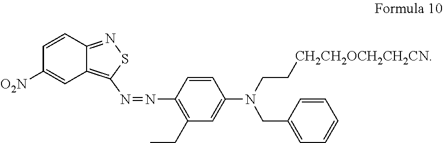

A twelfth objective of the disclosure is to provide a benzisothiazole disperse dye with a structural formula shown in Formula 11,

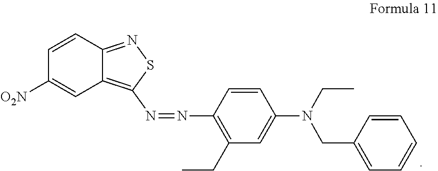 [SMILES: CCc1cc(N(CC)Cc2ccccc2)ccc1N=Nc1snc2ccc([N+](=O)[O-])cc12]

A thirteenth objective of the disclosure is to provide a benzisothiazole disperse dye with a structural formula shown in Formula 12,

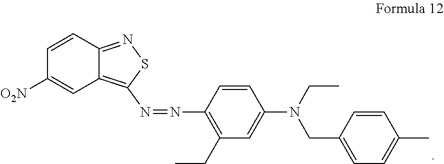 [SMILES: CCc1cc(N(CC)Cc2ccc(C)cc2)ccc1N=Nc1snc2ccc([N+](=O)[O-])cc12]

A fourteenth objective of the disclosure is to provide application of a benzisothiazole disperse dye in a one-bath process for cotton bleaching and disperse dyeing of a polyester-cotton blended fabric or a one-bath process for alkali deweighting and disperse dyeing of polyester fabrics.

In an embodiment of the disclosure, application of a benzisothiazole disperse dye in the one-bath process for cotton bleaching and disperse dyeing of a polyester-cotton blended fabric or the one-bath process for alkali deweighting and disperse dyeing of polyester fabrics specifically includes:

(1) preparing dyeing solutions at room temperature, wherein in the one-bath process for cotton bleaching and disperse dyeing of a polyester-cotton blended fabric, the use amount of the dye in the dyeing solution is 0.2-2% (weight to the fabric) of the weight of a polyester-cotton blended fabric, the pH of the dyeing solution is 10-11, the use amount of an alkali-resistant levelling agent in the dyeing solution is 0.5-2 g/L, hydrogen peroxide is 5-10 g/L, and a hydrogen peroxide stabilizer is 2 g/L; in the one-bath process for alkali deweighting and dyeing of polyester fabrics, the use amount of the dye in the dyeing solution is 0.2-2% of the weight of a polyester knitted fabric, the use amount of an alkali-resistant levelling agent is 0.5-2 g/L, the use amount of sodium hydroxide is 0-10 g/L, and the weight ratio of the dyeing solution to the fabric is 5-30:1;

(2) adding the polyester-cotton blended fabric or the polyester knitted fabric into the corresponding dyeing solution prepared in step (1), and obtaining a dyed polyester-cotton blended fabric or polyester knitted fabric by using a high-temperature and high-pressure dyeing method;

(3) performing reduction clearing on the dyed polyester-cotton blended fabric or polyester knitted fabric to obtain a polyester-cotton blended fabric dyed by using the one-bath process for cotton bleaching and disperse dyeing and a polyester knitted fabric dyed by using the one-bath process for alkali deweighting and disperse dyeing.

A fifteenth objective of the disclosure is to provide a method for evaluating the alkali resistance of a benzisothiazole disperse dye based on groups of a structural formula of the benzisothiazole disperse dye, wherein the structural formula of the benzisothiazole disperse dye is shown in Formula 1:

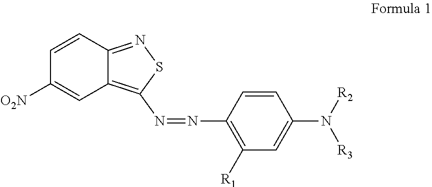

and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; alkyl groups involved are all C1-4 alkyl groups;

on the basis that R₁ is hydrogen, methyl, ethyl, methoxy or ethoxy and R₂ is linear or branched alkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl>the alkali resistance of a benzisothiazole disperse dye obtained when R₃ is cyanoalkyl, cyanoalkoxyalkyl or hydroxyalkyl;

on the basis that R₁ is hydrogen, methyl, ethyl, methoxy or ethoxy and R₂ is cyanoalkyl or cyanoalkoxyalkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl.

A sixteenth objective of the disclosure is to provide a method for evaluating the oxidation resistance of a benzisothiazole disperse dye based on groups of a structural formula of the benzisothiazole disperse dye when the pH=10, wherein the structural formula of the benzisothiazole disperse dye is shown in Formula 1:

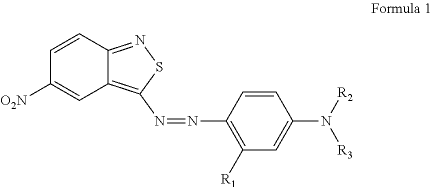

and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; alkyl groups involved are all C1-4 alkyl groups;

on the basis that R₁ is hydrogen, methyl, ethyl, methoxy or ethoxy and R₂ is linear or branched alkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is cyanoalkyl, cyanoalkoxyalkyl or hydroxyalkyl.

On the basis that R₁ is hydrogen, methyl, ethyl, methoxy or ethoxy and R₂ is cyanoalkyl or cyanoalkoxyalkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is alkyl.

Beneficial Effects of the Disclosure:

(1) Benzisothiazole heterocyclic azo disperse dyes designed and synthesized in the disclosure have high brightness, bright color, stable luster and other spectral properties.

(2) In the disclosure, azo alkali-resistant disperse dyes with benzisothiazole as the diazo component are synthesized based on structural design of the dyes, the alkali resistance and oxygen bleaching resistance of the heterocyclic azo disperse dyes are improved by introducing different groups to the coupling component, a series of benzisothiazole disperse dyes having gradient differences in alkali resistance and oxidation resistance are obtained, disperse dyes capable of meeting requirements of a one-bath process for cotton bleaching and disperse dyeing of a polyester-cotton blended fabric or a one-bath process for alkali deweighting and disperse dyeing of polyester fabrics are determined, and a reference can be provided for structural design of disperse dyes with alkali resistance and oxidation resistance.

(3) In the disclosure, an alkali resistance sequence of disperse dyes after different substituents are introduced is determined based on the alkali resistance stability of synthetic benzisothiazole disperse dyes, and the alkali resistance of a benzisothiazole disperse dye obtained when the N substituent in the coupling component is p-methylbenzyl or benzyl>the alkali resistance of a benzisothiazole disperse dye obtained when the N substituent in the coupling component is benzyl+cyano or benzyl+cyanoethoxyethyl>the alkali resistance of a benzisothiazole disperse dye obtained when the N substituent in the coupling component is ethyl>the alkali resistance of a benzisothiazole disperse dye obtained when the N substituent in the coupling component is cyanoethyl, cyanoethoxyethyl or hydroxyethyl.

(4) In the disclosure, an oxidation resistance sequence of synthetic benzisothiazole disperse dyes after different substituents are introduced is determined based on the oxidation resistance of this kind of disperse dyes, i.e. the oxidation resistance of a benzisothiazole disperse dye obtained when the N substituent in the coupling component is p-methylbenzyl, benzyl, ethyl, benzyl+cyano or benzyl+cyanoethoxyethyl>the oxidation resistance of a benzisothiazole disperse dye obtained when the N substituent in the coupling component is cyanoethyl, cyanoethoxyethyl or hydroxyethyl.

(5) According to the method for improving the alkali resistance and oxidation resistance of a benzisothiazole disperse dye provided in the disclosure, disperse dyes with excellent alkali resistance and oxidation resistance can be obtained, and requirements of the one-bath process for cotton bleaching and disperse dyeing of a polyester-cotton blended fabric for the disperse dyes can be met; at the same time, disperse dyes with high alkali resistance are also obtained, and requirements of the one-bath process for alkali deweighting and disperse dyeing of polyester fabrics for the disperse dyes can be met.

(6) According to the method of the disclosure, a polyester-cotton dyeing and finishing process flow is simplified, requirements of energy saving and emission reduction in the textile industry are met, and good social and economic benefits can be obtained.

### BRIEF DESCRIPTION OF FIGURES

FIG. 1 is a hydrogen nuclear magnetic resonance spectrum of a benzisothiazole disperse dye obtained in Example 1.

FIG. 2 is a hydrogen nuclear magnetic resonance spectrum of a benzisothiazole disperse dye obtained in Example 2.

FIG. 3 is a hydrogen nuclear magnetic resonance spectrum of a benzisothiazole disperse dye obtained in Example 3.

FIG. 4 is a hydrogen nuclear magnetic resonance spectrum of a benzisothiazole disperse dye obtained in Example 4.

FIG. 5 is a hydrogen nuclear magnetic resonance spectrum of a benzisothiazole disperse dye obtained in Example 6.

FIG. 6 is a hydrogen nuclear magnetic resonance spectrum of a benzisothiazole disperse dye obtained in Example 7.

### DETAILED DESCRIPTION

It should be understood that descriptions of the following preferred examples of the disclosure are used to better explain the disclosure, but not intended to limit the disclosure.

Performance Test Methods:

An alkali resistance test of a dye including a stability test under different pH values and a stability test under different NaOH concentrations and an oxidation resistance test of the dye are involved. Specific test steps include:

(1) preparing a dyeing solution at room temperature, wherein the use amount of a dye in the dyeing solution is 2% of the weight of a polyester knitted fabric, the use amount of an alkali-resistant levelling agent is 1 g/L, the weight ratio of the dyeing solution to the polyester knitted fabric is 30:1, a high-temperature and high-pressure dyeing method is used, and reduction clearing is performed on the polyester knitted fabric after dyeing to obtain a dyed polyester knitted fabric;

(2) testing the stability of a dye under different pH values, wherein a dye bath with a pH=3-13 is prepared, dyeing and reduction clearing after dyeing are performed on a polyester knitted fabric under different pH values according to a dyeing and reduction clearing process formula and a process flow in step (1), the stability of the dye under different pH values is tested, and the highest pH value when the color and luster of the dye are not changed is taken as the highest pH resistant value of the dye;

(3) testing the stability of a dye under different NaOH concentrations, wherein a test on high alkali resistance of a benzisothiazole disperse dye is performed when the pH is stable and ≥10, a dye bath with a NaOH concentration of 0-10 g/L is prepared, dyeing and reduction clearing after dyeing are performed on a polyester knitted fabric under different NaOH concentrations according to a dyeing and reduction clearing process formula and a process flow in step (1), the stability of the dye under different NaOH concentrations is tested, and the highest NaOH concentration when the color and luster of the dye are not changed is taken as the highest NaOH resistant concentration of the dye;

(4) testing the stability of a dye under different hydrogen peroxide concentrations, wherein since the optimal pH value of hydrogen peroxide for bleaching a cotton fabric is 10-11, the stability of the dye under different hydrogen peroxide concentrations is tested when the pH is 10, a dye bath with a hydrogen peroxide concentration of 0-5 g/L is prepared, dyeing and reduction clearing after dyeing are performed on a polyester knitted fabric under different hydrogen peroxide concentrations according to a dyeing and reduction clearing process formula and a process flow in step (1) under the condition that the concentration of a hydrogen peroxide stabilizer (stabilizer DM1403) is 2 g/L, the stability of the dye under different hydrogen peroxide concentrations is tested, and the highest hydrogen peroxide concentration when the color and luster of the dye are not changed is taken as the highest hydrogen peroxide resistant concentration of the dye.

### Example 1

A benzisothiazole disperse dye with a structural formula shown below is provided,

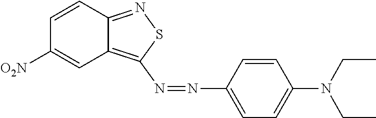 [SMILES: CCN(CC)c1ccc(N=Nc2snc3ccc([N+](=O)[O-])cc23)cc1]

A synthetic route is:

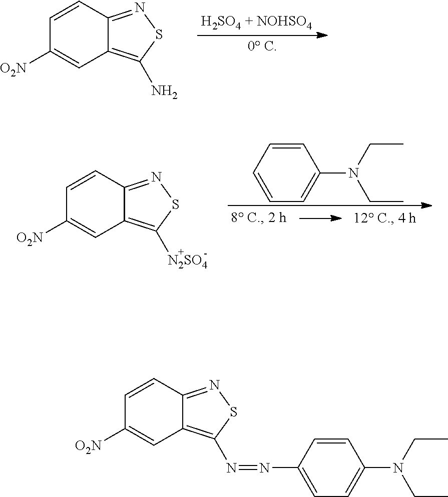

A preparation method of the benzisothiazole disperse dye includes the following steps:

(1) performing a diazo reaction: adding 3-amino-5-nitrobenzisothiazole (19.5 g, 0.1 mol) into a single-neck flask, adding 50 ml of 98% concentrated H₂SO₄, reducing the temperature to 0° C., adding an appropriate amount (12.7 g) of nitrosyl sulfuric acid under stirring (300-500 rpm), performing uniform stirring and detection with a starch-potassium iodide test paper until the color is blue to ensure that nitrosyl sulfuric acid is excessive, performing a reaction continuously for 3 h, adding 3.88 g of nitrosyl sulfuric acid to remove excessive nitrosyl sulfuric acid after the reaction is completed, and performing stirring at 0° C. for 15 min to obtain a diazo solution;

(2) performing a coupling reaction: adding 60 mL of water, 2 mL of H₂SO₄ and a coupling component (N,N-diethylaniline (0.1 mol)) into a double-neck flask, and reducing the temperature to 8° C. to obtain a coupling solution; slowly adding the diazo solution obtained in step (1) dropwise into the coupling solution under stirring for performing a reaction continuously at 8° C. for 2 h, increasing the temperature to 12° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) dissolving the filter cake obtained in step (2) in a 95% ethanol solution (the filter cake can be dissolved in the ethanol solution), and performing reflux at 70° C. for 2 h, cooling, recrystallization, filtration and drying to obtain a benzisothiazole disperse dye.

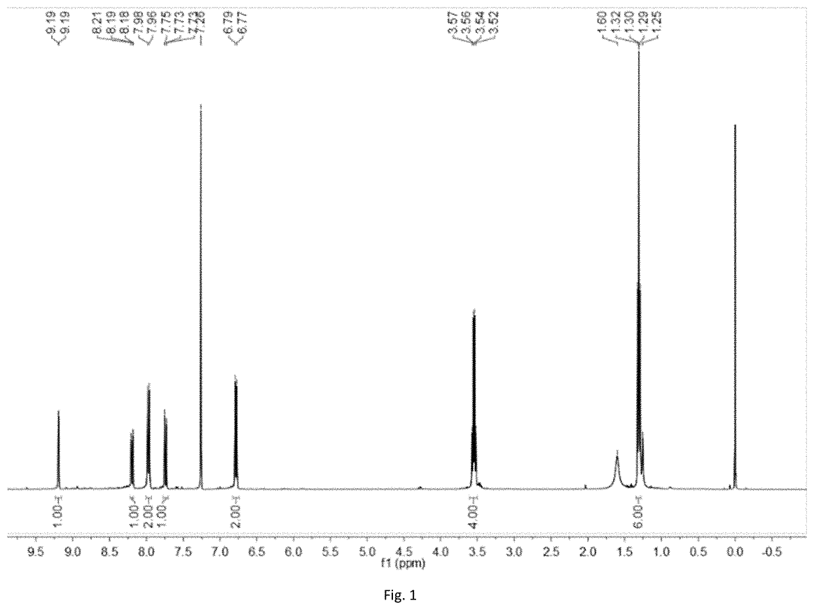

Structural characterization is performed on the obtained benzisothiazole disperse dye, and results (as shown in FIG. 1) of hydrogen nuclear magnetic resonance spectrum are:

¹H NMR (400 MHz, CDCl₃) δ 9.19 (d, 1H, ═CH—, 3), 8.19 (d, 1H, —CH═, 1), 7.97 (d, 2H, ═CH—, 4 and 6), 7.76-7.71 (d, 1H, ═CH—, 2), 7.26 (s, CDCl₃), 6.77 (d, 1H, ═CH—, 5), 6.79 (d, 1H, —CH═, 7), 3.55 (q, 4H, —CH₂—, 8 and 10), 1.60 (s, H₂O), 1.3 (t, 6H, —CH₃, 9 and 11).

### Example 2

A benzisothiazole disperse dye with a structural formula shown below is provided,

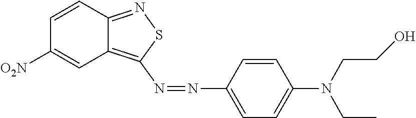 [SMILES: CCN(CCO)c1ccc(N=Nc2snc3ccc([N+](=O)[O-])cc23)cc1]

A synthetic route is:

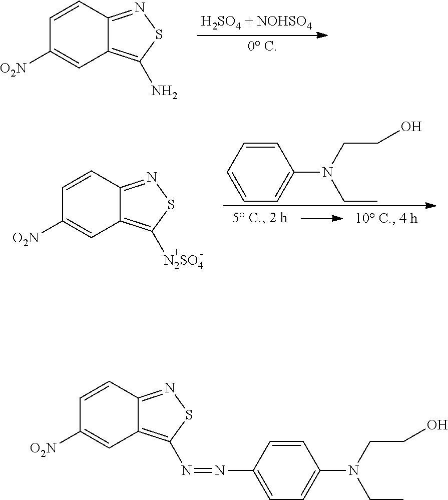

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-hydroxyethylaniline (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

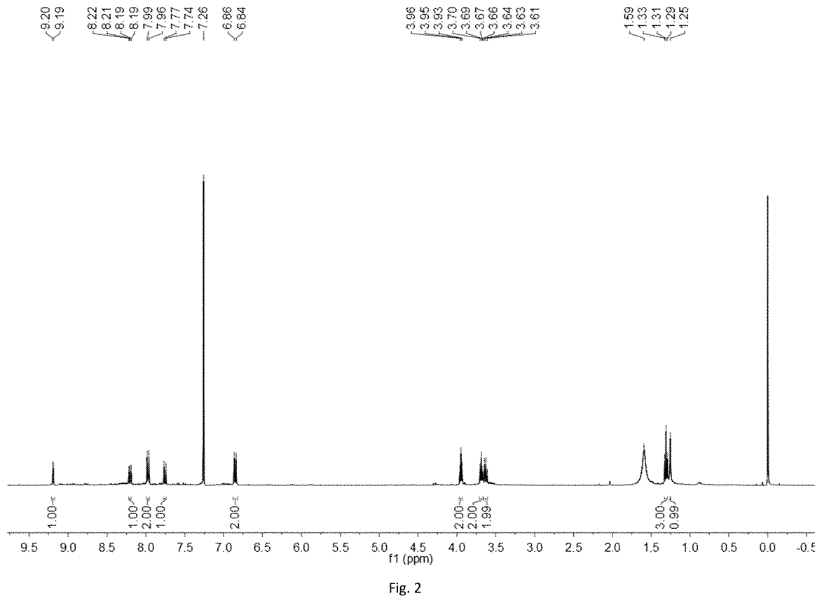

Structural characterization is performed on the obtained benzisothiazole disperse dye, and results (as shown in FIG. 2) of hydrogen nuclear magnetic resonance spectrum are:

¹H NMR (400 MHz, CDCl₃) δ 9.19 (d, 1H, ═CH—, 3), 8.20 (d, 1H, —CH═, 1), 7.97 (d, 2H, ═CH—, 5 and 7), 7.76 (d, 1H, ═CH—, 2), 7.26 (s, CDCl₃), 6.86 (d, 2H, —CH═, 4), 6.84 (d, 2H, ═CH—, 6), 3.95 (t, 2H, —CH—, 10), 3.69 (t, 2H, —CH—, 11), 3.66-3.61 (q, 2H, —CH—, 8), 1.59 (s, H₂O), 1.31 (t, 3H, —CH₃, 9), 1.25 (d, 1H, —OH, 12).

### Example 3

A benzisothiazole disperse dye with a structural formula shown below is provided,

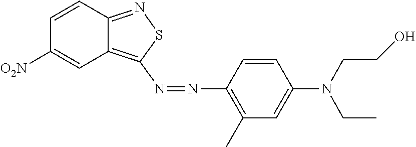 [SMILES: CCN(CCO)c1ccc(N=Nc2snc3ccc([N+](=O)[O-])cc23)c(C)c1]

A synthetic route is:

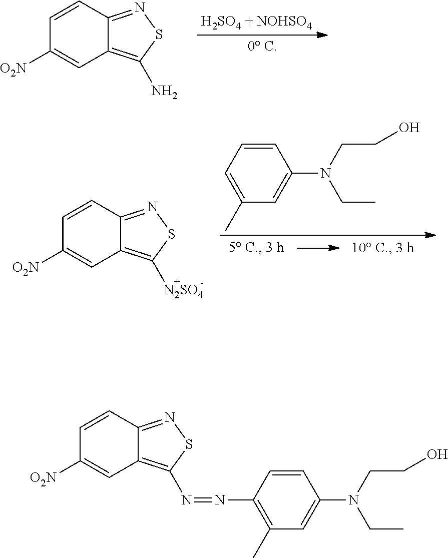

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-hydroxyethyl-m-toluidine (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

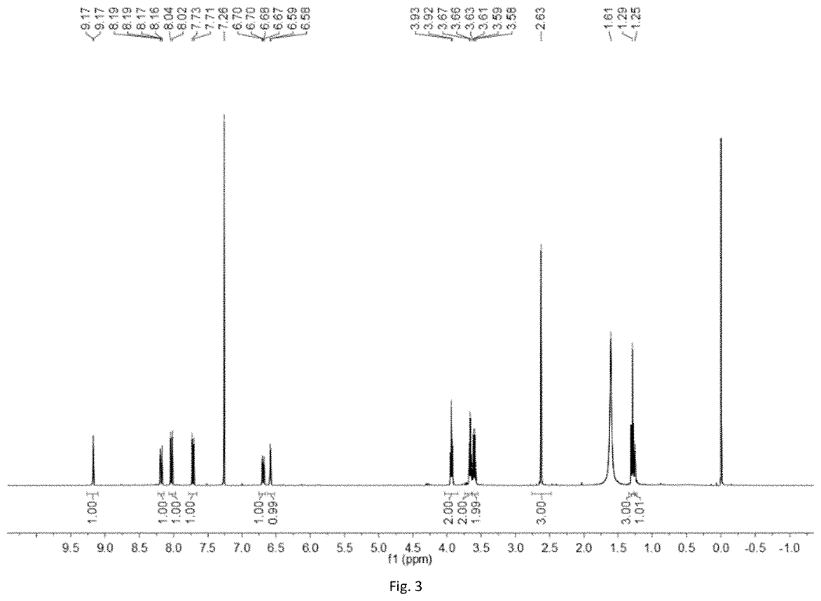

Structural characterization is performed on the obtained benzisothiazole disperse dye, and results (as shown in FIG. 3) of hydrogen nuclear magnetic resonance spectrum are:

¹H NMR (400 MHz, CDCl₃) δ 9.17 (d, 1H, ═CH—, 3), 8.18 (d, 1H, —CH═, 1), 8.03 (d, 1H, ═CH—, 2), 7.72 (d, 1H, —CH═, 4), 7.26 (s, CDCl₃), 6.69 (d, 1H, ═CH—, 5), 6.58 (s, 1H, ═CH—, 7), 3.93 (t, 2H, —CH₂—, 10), 3.67 (q, 2H, —CH₂—, 11), 3.60 (q, 2H, —CH₂—, 8), 2.63 (s, 3H, —CH₃, 6), 1.61 (s, H₂O), 1.29 (t, 3H, —CH₃, 9), 1.25 (t, 1H, —OH, 12).

### Example 4

A benzisothiazole disperse dye with a structural formula shown below is provided,

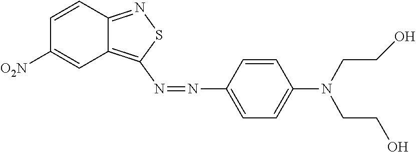 [SMILES: O=[N+]([O-])c1ccc2nsc(N=Nc3ccc(N(CCO)CCO)cc3)c2c1]

A synthetic route is:

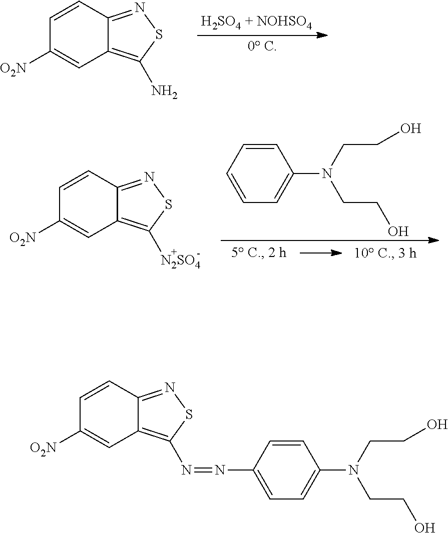

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N,N-dihydroxyethylaniline (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

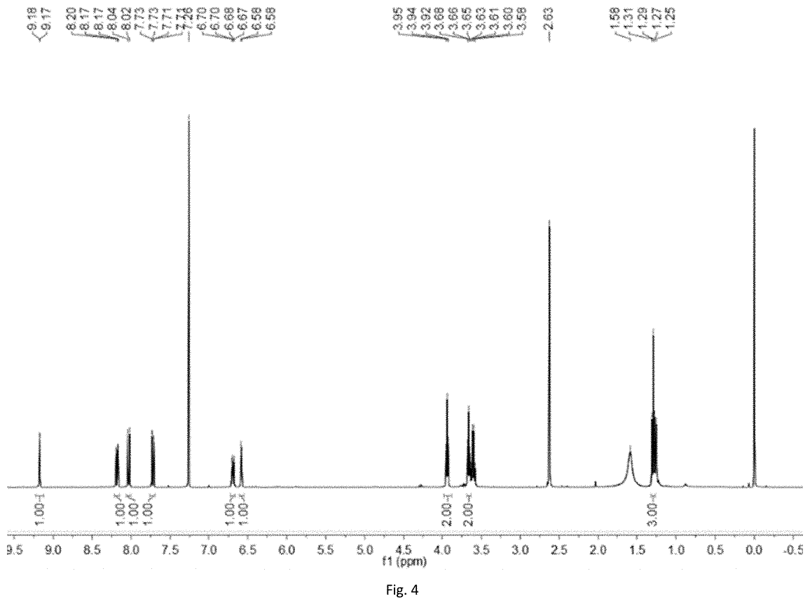

Structural characterization is performed on the obtained benzisothiazole disperse dye, and results (as shown in FIG. 4) of hydrogen nuclear magnetic resonance spectrum are:

¹H NMR (400 MHz, CDCl₃) δ 9.17 (d, 1H, ═CH—, 3), 8.18 (d, 1H, —CH═, 1), 8.03 (d, 1H, ═CH—, 4), 7.72 (d, 1H, ═CH—, 6), 7.26 (s, CDCl₃), 6.58 (d, 1H, ═CH—, 2), 3.94 (d, 2H, ═CH—, 5 and 7), 3.69-3.57 (q, 4H, —CH₂—, 9 and 12), 2.63 (s, 2H, —OH, 10 and 13), 1.58 (s, H₂O), 1.29 (t, 4H, —CH₂—, 8 and 11).

### Example 5

A benzisothiazole disperse dye with a structural formula shown below is provided,

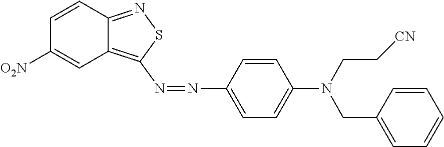 [SMILES: N#CCCN(Cc1ccccc1)c1ccc(N=Nc2snc3ccc([N+](=O)[O-])cc23)cc1]

A synthetic route is:

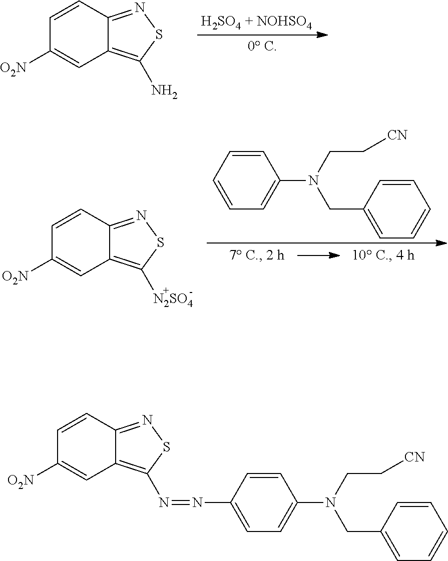

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-cyanoethyl-N-benzylaniline (0.1 mol)) into a double-neck flask, and reducing the temperature to 7° C. to obtain a coupling solution; slowly adding a diazo solution obtained in step (1) dropwise into the coupling solution under stirring for performing a reaction continuously at 7° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Structural characterization is performed on the obtained benzisothiazole disperse dye, and results of hydrogen nuclear magnetic resonance spectrum are:

¹H NMR (400 MHz, CDCl₃) δ 9.18 (d, 1H, ═CH—, 3), 8.24-8.21 (d, 1H, —CH═, 1), 8.02 (d, 1H, ═CH—, 6), 8.00 (d, 1H, ═CH—, 4), 7.79 (d, 1H, ═CH—, 2), 7.38-7.30 (m, 5H, Ar—H, 11), 7.26 (s, CDCl₃), 6.88 (d, 2H, ═CH—, 5), 6.77 (d, 2H, ═CH—, 7), 4.85 (s, 2H, —CH₂—, 10), 4.61 (s, 2H), 3.75 (t, 2H, —CH₂—, 8), 2.76 (t, 2H, —CH₂—, 9), 1.58 (s, H₂O).

### Example 6

A benzisothiazole disperse dye with a structural formula shown below is provided,

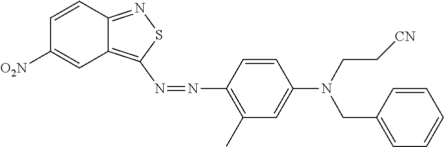 [SMILES: Cc1cc(N(CCC#N)Cc2ccccc2)ccc1N=Nc1snc2ccc([N+](=O)[O-])cc12]

A synthetic route is:

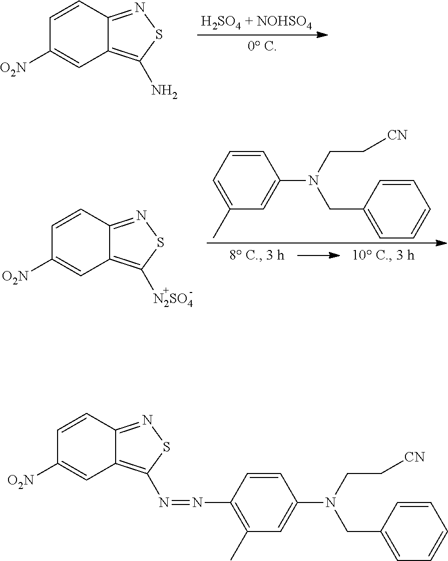

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-cyanoethyl-N-benzyl-m-toluidine (0.1 mol)) into a double-neck flask, and reducing the temperature to 8° C. to obtain a coupling solution; slowly adding a diazo solution obtained in step (1) dropwise into the coupling solution under stirring for performing a reaction continuously at 8° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

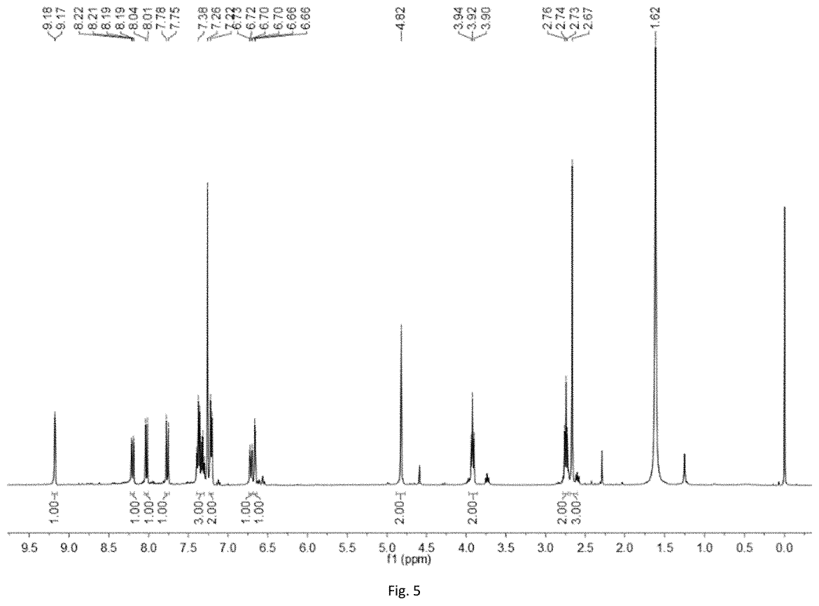

Structural characterization is performed on the obtained benzisothiazole disperse dye, and results (as shown in FIG. 5) of hydrogen nuclear magnetic resonance spectrum are:

¹H NMR (400 MHz, CDCl₃) δ 9.18 (d, 1H, ═CH—, 3), 8.20 (d, 1H, —CH═, 1), 8.03 (d, 1H, ═CH—, 2), 7.77 (d, 1H, —CH═, 4), 7.39-7.30 (m, 3H, Ar—H, 11), 7.26 (s, CDCl₃), 7.21 (d, 2H, Ar—H, 11), 6.71 (d, 1H, ═CH—, 5), 6.66 (d, 1H, ═CH—, 7), 4.82 (s, 2H, —CH₂—, 10), 3.92 (t, 2H, —CH₂—, 8), 2.74 (t, 2H, —CH₂—, 10), 2.67 (s, 3H, —CH₃, 6), 1.62 (s, H₂O).

### Example 7

A benzisothiazole disperse dye with a structural formula shown below is provided,

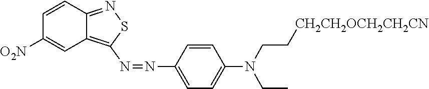

A synthetic route is:

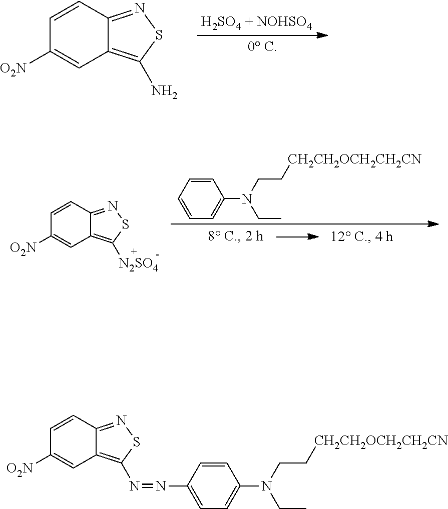

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-cyanoethoxyethylaniline (0.1 mol)) into a double-neck flask, and reducing the temperature to 8° C. to obtain a coupling solution; slowly adding a diazo solution obtained in step (1) dropwise into the coupling solution under stirring for performing a reaction continuously at 8° C. for 2 h, increasing the temperature to 12° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

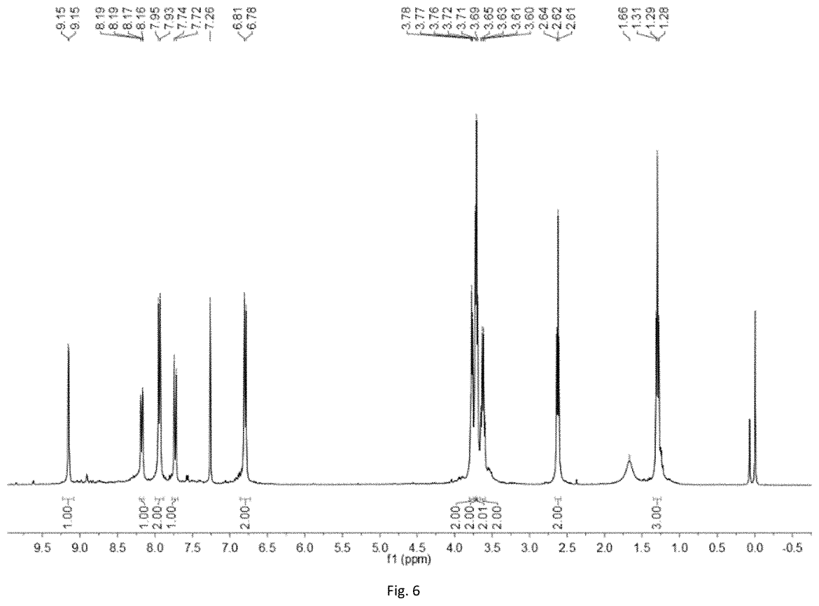

Structural characterization is performed on the obtained benzisothiazole disperse dye, and results (as shown in FIG. 6) of hydrogen nuclear magnetic resonance spectrum are:

¹H NMR (400 MHz, CDCl₃) δ 9.15 (d, 1H, ═CH—, 3), 8.18 (d, 1H, —CH═, 1), 7.94 (d, 2H, —CH═, 4 and 6), 7.73 (d, 1H, ═CH—, 2), 7.26 (s, CDCl₃), 6.80 (d, —CH═, 2H, 5 and 7), 3.77 (m, 2H, —CH₂—, 11), 3.72 (s, 1H, —CH₂—, 12), 3.71 (m, 2H, —CH₂—, 10), 3.69-3.56 (m, 3H, —CH₃, 9), 2.62 (t, 2H, —CH₂—, 8), 1.66 (s, H₂O), 1.29 (t, 3H, —CH₂, 13).

### Example 8

A benzisothiazole disperse dye with a structural formula shown below is provided,

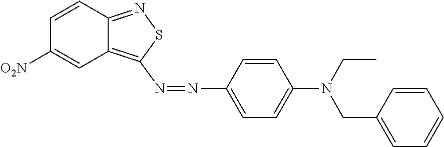 [SMILES: CCN(Cc1ccccc1)c1ccc(N=Nc2snc3ccc([N+](=O)[O-])cc23)cc1]

A synthetic route is:

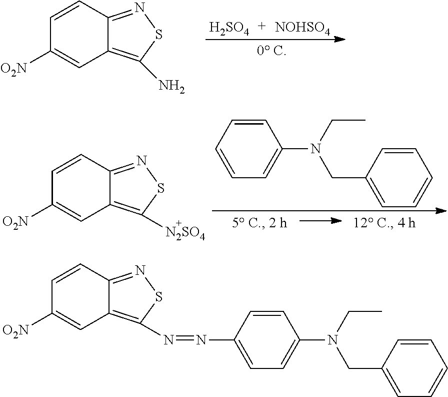

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-benzylaniline) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 12° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Structural characterization is performed on the obtained benzisothiazole disperse dye, and results of hydrogen nuclear magnetic resonance spectrum are:

¹H NMR (400 MHz, CDCl₃) δ 9.22-9.13 (m, 1H, CH—, 3), 8.19 (d, 1H, CH—, 3), 7.95 (d, 2H, ═CH—, 4 and 6), 7.74 (d, 1H, ═CH—, 2), 7.38-7.28 (m, 3H, Ar—H, 11), 7.26 (s, CDCl₃), 7.22 (d, 2H, Ar—H, 11), 6.82 (d, 2H, ═CH—, 6 and 7), 4.72 (s, 2H, —CH₂—, 10), 3.66 (q, 2H, —CH₂—, 8), 1.62 (s, H₂O), 1.34 (t, 3H, —CH₃, 9).

### Example 9

A benzisothiazole disperse dye with a structural formula shown below is provided,

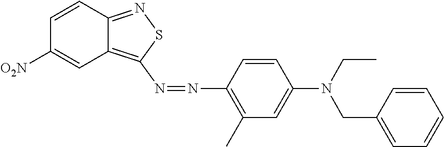 [SMILES: CCN(Cc1ccccc1)c1ccc(N=Nc2snc3ccc([N+](=O)[O-])cc23)c(C)c1]

A synthetic route is:

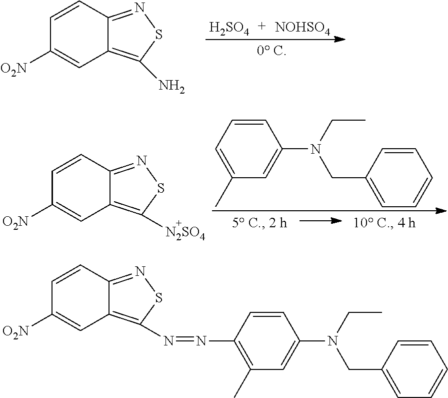

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-benzyl-m-toluidine) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Structural characterization is performed on the obtained benzisothiazole disperse dye, and results of hydrogen nuclear magnetic resonance spectrum are:

¹H NMR (400 MHz, CDCl₃) δ 9.17 (d, 1H, ═CH—, 1), 8.19 (d, 1H, ═CH—, 3), 7.95 (d, 1H, ═CH—, 4), 7.74 (d, 1H, ═CH—, 2), 7.33 (dt, 3H, Ar—H, 11), 7.26 (s, CDCl₃), 7.22 (d, 2H, Ar—H, 11), 6.83 (d, ═CH—, 6 and 7), 4.73 (s, 2H, —CH₂—, 10), 3.70-3.62 (m, 2H, —CH₂—, 8), 1.59 (s, H₂O), 1.34 (t, 3H, —CH₃, 9).

### Example 10

A benzisothiazole disperse dye with a structural formula shown below is provided,

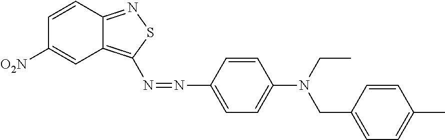 [SMILES: CCN(Cc1ccc(C)cc1)c1ccc(N=Nc2snc3ccc([N+](=O)[O-])cc23)cc1]

A synthetic route is:

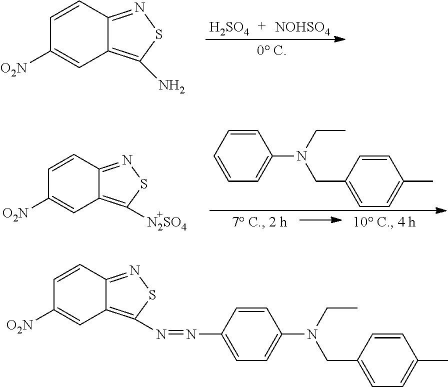

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-p-methylbenzylaniline) into a double-neck flask, and reducing the temperature to 7° C. to obtain a coupling solution; slowly adding a diazo solution obtained in step (1) dropwise into the coupling solution under stirring for performing a reaction continuously at 7° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Structural characterization is performed on the obtained benzisothiazole disperse dye, and results of hydrogen nuclear magnetic resonance spectrum are:

¹H NMR (400 MHz, CDCl₃) δ 9.15 (d, 1H, ═CH—, 3), 8.18 (d, 1H, —CH═, 1), 7.94 (d, 2H, ═CH—, 4 and 6), 7.73 (d, 1H, ═CH—, 2), 7.26 (s, CDCl₃), 6.80 (d, 2H, ═CH—, 5 and 7), 3.77 (q, 2H, ═CH—, 11 and 13), 3.72 (s, 1H, —CH₂—, 10), 3.71 (q, 2H, ═CH—, 12 and 14), 3.70-3.58 (m, 3H, —CH₃, 9), 2.62 (t, 2H, —CH₂—, 8), 1.66 (s, H₂O), 1.29 (s, 3H, —CH₃, 15).

### Example 11

A benzisothiazole disperse dye with a structural formula shown below is provided,

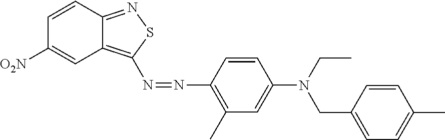 [SMILES: CCN(Cc1ccc(C)cc1)c1ccc(N=Nc2snc3ccc([N+](=O)[O-])cc23)c(C)c1]

A synthetic route is:

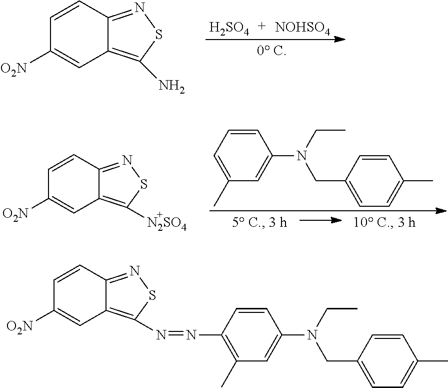

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-p-methylbenzyl-m-toluidine) into a double-neck flask, and reducing the temperature to 5° C. to obtain a coupling solution; slowly adding a diazo solution obtained in step (1) dropwise into the coupling solution under stirring for performing a reaction continuously at 5° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Structural characterization is performed on the obtained benzisothiazole disperse dye, and results of hydrogen nuclear magnetic resonance spectrum are:

¹H NMR (400 MHz, CDCl₃) δ 9.16 (d, 1H, ═CH—, 3), 8.18 (d, 1H, ═CH—, 1), 8.03 (d, 1H, ═CH—, 4), 7.72 (1H, ═CH—, 2), 7.26 (s, CDCl₃), 7.16 (d, 2H, ═CH—, 11 and 13), 7.10 (d, 2H, ═CH—, 12 and 14), 6.69 (d, 1H, ═CH—, 5), 6.62 (d, 1H, ═CH—, 7), 4.67 (s, 2H, —CH₂—, 10), 3.61 (d, 2H, —CH₂—, 8), 2.63 (s, 3H, —CH₃, 6), 2.35 (s, 3H, —CH₃, 15), 1.56 (s, H₂O), 1.32 (s, 3H, —CH₃, 9).

### Example 12

A benzisothiazole disperse dye with a structural formula shown below is provided,

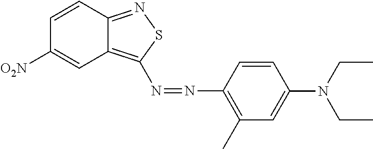 [SMILES: CCN(CC)c1ccc(N=Nc2snc3ccc([N+](=O)[O-])cc23)c(C)c1]

A synthetic route is:

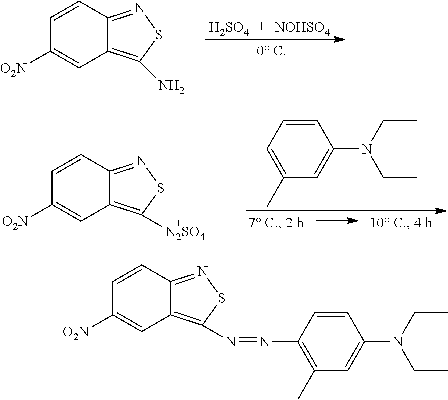

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N,N-diethyl-m-toluidine (0.1 mol)) into a double-neck flask, and reducing the temperature to 7° C. to obtain a coupling solution; slowly adding a diazo solution obtained in step (1) dropwise into the coupling solution under stirring for performing a reaction continuously at 7° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 13

A benzisothiazole disperse dye with a structural formula shown below is provided,

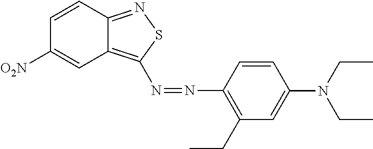 [SMILES: CCc1cc(N(CC)CC)ccc1N=Nc1snc2ccc([N+](=O)[O-])cc12]

A synthetic route is:

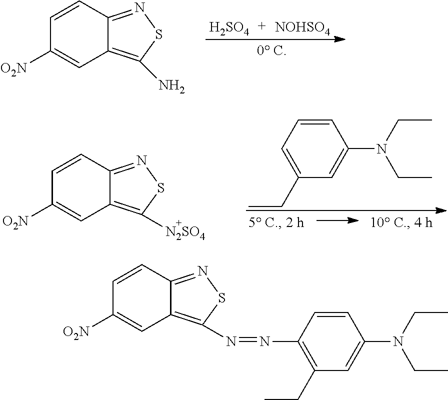

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N,N-diethyl-m-ethylaniline (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 14

A benzisothiazole disperse dye with a structural formula shown below is provided,

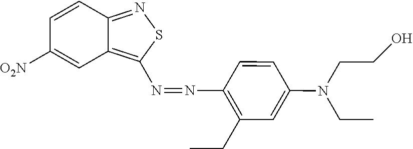 [SMILES: CCc1cc(N(CC)CCO)ccc1N=Nc1snc2ccc([N+](=O)[O-])cc12]

A synthetic route is:

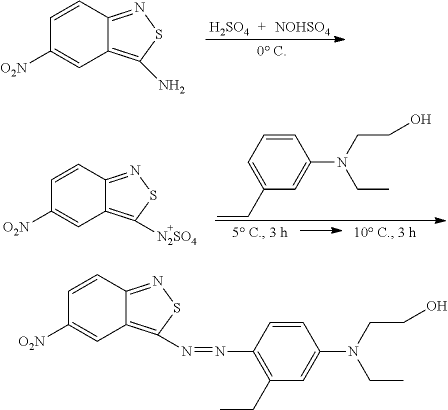

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-hydroxyethyl-m-ethylaniline (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 15

A benzisothiazole disperse dye with a structural formula shown below is provided,

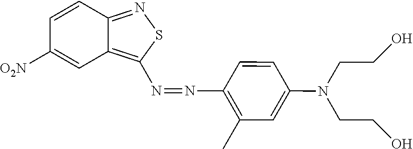 [SMILES: Cc1cc(N(CCO)CCO)ccc1N=Nc1snc2ccc([N+](=O)[O-])cc12]

A synthetic route is:

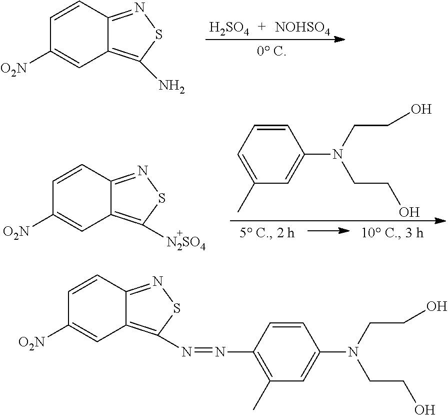

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N,N-dihydroxyethyl-m-toluidine (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 16

A benzisothiazole disperse dye with a structural formula shown below is provided,

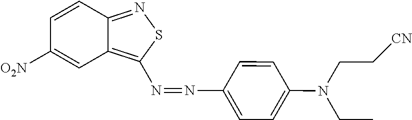 [SMILES: CCN(CCC#N)c1ccc(N=Nc2snc3ccc([N+](=O)[O-])cc23)cc1]

A synthetic route is:

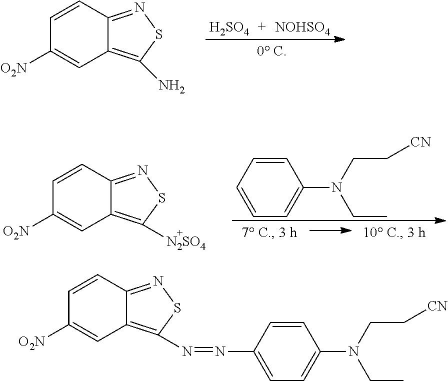

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-cyanoethylaniline (0.1 mol)) into a double-neck flask, and reducing the temperature to 7° C. to obtain a coupling solution; slowly adding a diazo solution obtained in step (1) dropwise into the coupling solution under stirring for performing a reaction continuously at 7° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 17

A benzisothiazole disperse dye with a structural formula shown below is provided,

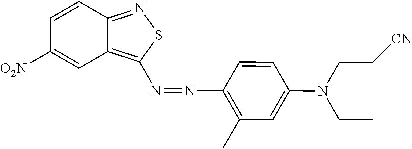 [SMILES: CCN(CCC#N)c1ccc(N=Nc2snc3ccc([N+](=O)[O-])cc23)c(C)c1]

A synthetic route is:

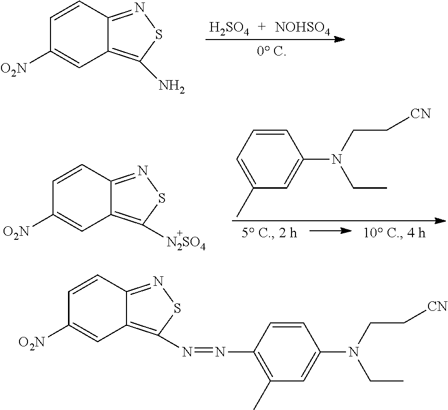

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-cyanoethyl-m-toluidine (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 18

A benzisothiazole disperse dye with a structural formula shown below is provided,

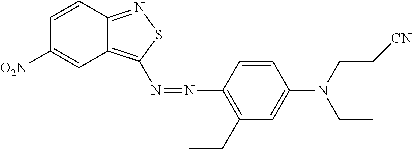 [SMILES: CCc1cc(N(CC)CCC#N)ccc1N=Nc1snc2ccc([N+](=O)[O-])cc12]

A synthetic route is:

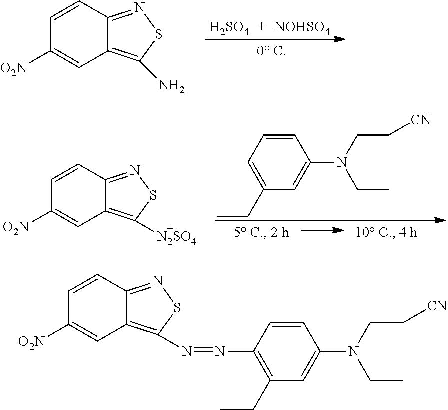

A preparation method of the benzisothiazole disperse dye includes the following steps:

(1) performing a diazo reaction, wherein conditions were the same as those in step (1) in Example 1;

(2) performing a coupling reaction: adding 60 mL of water, 2 mL of H₂SO₄ and a coupling component (N-ethyl-N-cyanoethyl-m-ethylaniline (0.1 mol)) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 19

A benzisothiazole disperse dye with a structural formula shown below is provided,

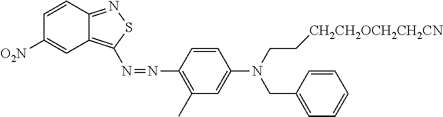

A synthetic route is:

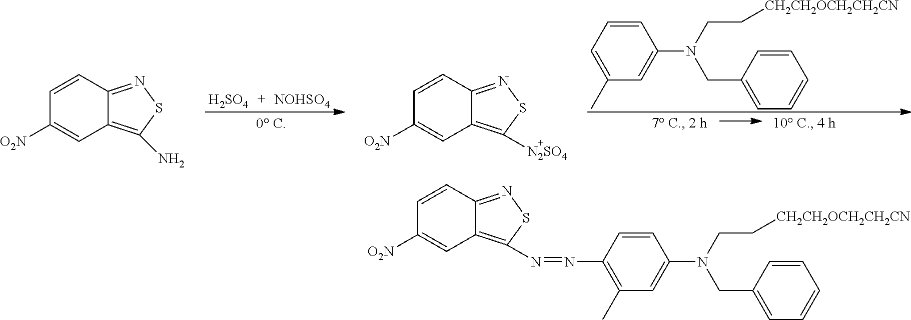

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-cyanoethoxyethyl-N-benzyl-m-toluidine (0.1 mol)) into a double-neck flask, and reducing the temperature to 7° C. to obtain a coupling solution; slowly adding a diazo solution obtained in step (1) dropwise into the coupling solution under stirring for performing a reaction continuously at 7° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 20

A benzisothiazole disperse dye with a structural formula shown below is provided,

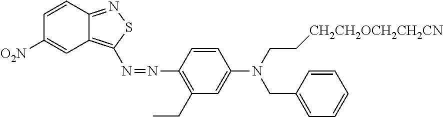

A synthetic route is:

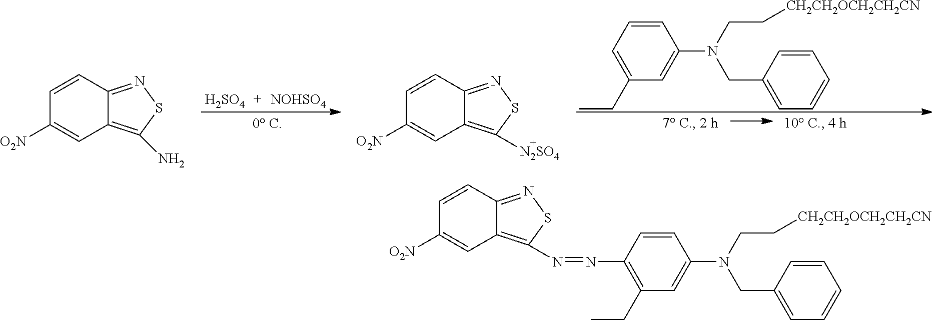

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-cyanoethoxyethyl-N-benzyl-m-ethylaniline (0.1 mol)) into a double-neck flask, and reducing the temperature to 7° C. to obtain a coupling solution; slowly adding a diazo solution obtained in step (1) dropwise into the coupling solution under stirring for performing a reaction continuously at 7° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 21

A benzisothiazole disperse dye with a structural formula shown below is provided,

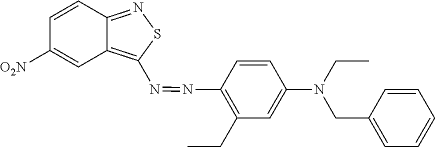 [SMILES: CCc1cc(N(CC)Cc2ccccc2)ccc1N=Nc1snc2ccc([N+](=O)[O-])cc12]

A synthetic route is:

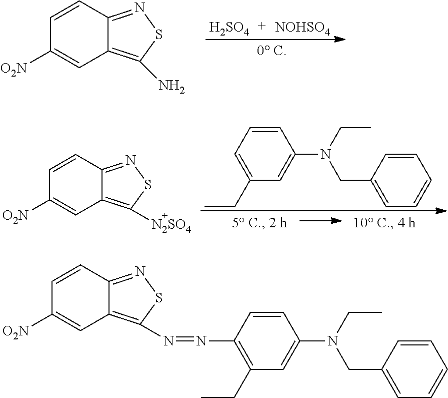

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-benzyl-m-ethylaniline) into a double-neck flask, and reducing the temperature to 5° C. to obtain a coupling solution; slowly adding a diazo solution obtained in step (1) dropwise into the coupling solution under stirring for performing a reaction continuously at 5° C. for 2 h, increasing the temperature to 10° C. for performing a reaction continuously for 4 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

### Example 22

A benzisothiazole disperse dye with a structural formula shown below is provided,

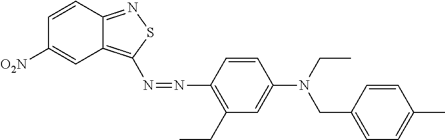 [SMILES: CCc1cc(N(CC)Cc2ccc(C)cc2)ccc1N=Nc1snc2ccc([N+](=O)[O-])cc12]

A synthetic route is:

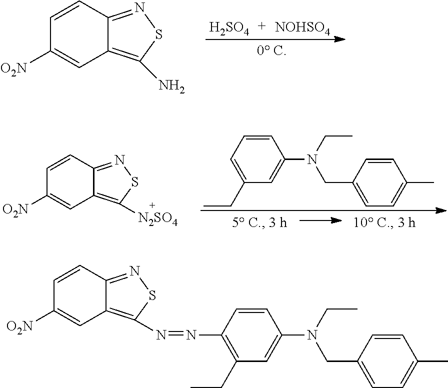

A preparation method of the benzisothiazole disperse dye includes the following steps:

(1) performing a diazo reaction, wherein conditions were the same as those in step (1) in Example 1;

(2) performing a coupling reaction: adding 60 mL of water, 3 mL of H₂SO₄ and a coupling component (N-ethyl-N-p-methylbenzyl-m-ethylaniline) into a double-neck flask, and reducing the temperature to 5° C. to obtain a coupling solution; slowly adding a diazo solution obtained in step (1) dropwise into the coupling solution under stirring for performing a reaction continuously at 5° C. for 3 h, increasing the temperature to 10° C. for performing a reaction continuously for 3 h, and after the reaction is completed, adding sodium hydroxide to adjust the pH to neutral to obtain a product; performing suction filtration, washing and drying on the obtained product to obtain a filter cake;

(3) performing operation with conditions same as those in step (3) in Example 1.

Performance testes on performed on the benzisothiazole disperse dyes obtained in Examples 1-22, and the alkali resistance, oxidation resistance, washing resistance, rubbing resistance, sunlight resistance and color fastness to sublimation of the dyes are shown in Table 1.

### Comparative Example 1

The alkali resistance, oxidation resistance, washing resistance, rubbing resistance, sunlight resistance and color fastness to sublimation of conventional monoazo disperse dyes (disperse red 2B, disperse yellow BRL and disperse blue BBLS) are shown in Table 1.

TABLE 1
Related properties of dyes

| | | | | Oxidation | | | | |
|---|---|---|---|---|---|---|---|---|
| | | | | resistance | | | | |
| | | Alkali resistance | | Highest | | | | |
| | | | Highest | hydrogen | | | | |
| | | Highest | NaOH | peroxide | | | | |
| | Dye | pH | resistant | resistant | | | | |
| | number | resistant | concentration | concentration | Washing | Rubbing | Sunlight | Sublimation |
| | or name | value | (g/L) | (g/L) | resistance | resistance | resistance | resistance |
| Example | 1 | 12 | 1 | 5 | 4-5 | 4-5 | 4-5 | 3-4 |
| | 2 | 9 | 0 | 0 | 4 | 4-5 | 5 | 5 |
| | 3 | 9 | 0 | 0 | 4-5 | 4 | 4-5 | 4-5 |
| | 4 | 9 | 0 | 0 | 4 | 4-5 | 4-5 | 4-5 |
| | 5 | 12 | 3 | 5 | 4-5 | 4-5 | 6 | 5 |
| | 6 | 12 | 3 | 5 | 4-5 | 5 | 7 | 5 |
| | 7 | 9 | 0 | 0 | 4 | 4-5 | 6-7 | 5 |
| | 8 | 13 | 10 | 5 | 5 | 4-5 | 6 | 4-5 |
| | 9 | 13 | 10 | 5 | 5 | 5 | 6-7 | 4 |
| | 10 | 13 | 10 | 5 | 4-5 | 5 | 7 | 4-5 |
| | 11 | 13 | 10 | 5 | 5 | 5 | 6-7 | 5 |
| | 12 | 12 | 1 | 5 | 4-5 | 4-5 | 2-3 | 4 |
| | 13 | 12 | 1 | 5 | 5 | 4-5 | 5-6 | 4 |
| | 14 | 9 | 0 | 0 | 4-5 | 5 | 5 | 4-5 |
| | 15 | 9 | 0 | 0 | 5 | 4-5 | 5 | 5 |
| | 16 | 9 | 0 | 0 | 4-5 | 5 | 6-7 | 5 |
| | 17 | 9 | 0 | 0 | 4-5 | 5 | 7 | 4-5 |
| | 18 | 9 | 0 | 0 | 4 | 4-5 | 6-7 | 4-5 |
| | 19 | 12 | 3 | 5 | 4-5 | 5 | 6-7 | 4-5 |
| | 20 | 12 | 3 | 5 | 5 | 4-5 | 7 | 4-5 |
| | 21 | 13 | 10 | 5 | 4-5 | 5 | 5-6 | 5 |
| | 22 | 13 | 10 | 5 | 5 | 4-5 | 6 | 4-5 |
| Comparative | Disperse | 6 | 0 | 0 | 5 | 5 | 7 | 5 |
| Example | red 2B | | | | | | | |
| | Disperse | 6 | 0 | 0 | 4-5 | 5 | 4-5 | 4-5 |
| | yellow BRL | | | | | | | |
| | Disperse | 6 | 0 | 0 | 4-5 | 4-5 | 6 | 4-5 |
| | blue BBLS | | | | | | | |

Note:
A test of color fastness to rubbing, a test of color fastness to washing, a test of color fastness to sunlight and a test of color fastness to sublimation are performed based on relevant regulations of GB/T3920.2008 Textiles-Color Fastness Test-Color Fastness to Rubbing, AATCC TM 61-2009 Colorfastness to Laundering: Accelerated A2, GB/T8427.2008 Textiles-Test for Color Fastness-Color Fastness to Artificial Light: Xenon Arc Fading Lamp Test and GB/T6152-1997 Textiles-Tests for Color Fastness-Color Fastness to Hot Pressing respectively.

By comparing Examples 1-22 and comparative examples in Table 1, it can be seen that among benzisothiazole disperse dyes designed and synthesized in Examples 1-22, the color and luster of the disperse dye with the lowest alkali resistance in a dye bath when the pH=9 are still stable, and the alkali resistance is higher than that of conventional disperse dyes; among the benzisothiazole disperse dyes designed and synthesized in Examples 1-22, the oxidation resistance of the benzisothiazole disperse dye with the highest pH resistant value greater than or equal to 10 when the pH=10 is higher than that of conventional disperse dyes, and the highest hydrogen peroxide resistant concentration can reach 5 g/L. In addition, various kinds of fastness of the benzisothiazole disperse dyes designed and synthesized in Examples 1-22 are excellent.

The benzisothiazole heterocyclic azo disperse dyes designed and synthesized in Examples 1-22 have high brightness, bright color, stable luster and other spectral properties; azo alkali-resistant disperse dyes with 3-amino-5-nitrobenzisothiazole as the diazo component and aniline derivatives as the coupling component are synthesized based on structural design of the dyes, the alkali resistance and oxygen bleaching resistance of the heterocyclic azo disperse dyes can be improved by introducing different groups to the coupling component, an alkali resistance sequence and an oxidation resistance sequence of the disperse dyes after different substituents are introduced are determined, and structural characteristics of the benzisothiazole disperse dyes with high alkali resistance and high oxidation resistance are obtained; a reference is provided for structural design of disperse dyes with alkali resistance and oxidation resistance, and disperse dyes capable of meeting requirements of a one-bath process for cotton bleaching and disperse dyeing of a polyester-cotton blended fabric or a one-bath process for alkali deweighting and disperse dyeing of polyester fabrics are determined; besides, according to the method for improving the alkali resistance and oxidation resistance of a benzisothiazole disperse dye provided in the examples, compared with conventional dyes, the alkali resistance and oxidation resistance of the disperse dyes are higher; under a dyeing condition of 10 g/L of sodium hydroxide or 5 g/L of hydrogen peroxide, a K/S value of a polyester knitted fabric dyed with these disperse dyes is still stable, and requirements of the one-bath process for cotton bleaching and disperse dyeing of a polyester-cotton blended fabric or the one-bath process for alkali deweighting and disperse dyeing of polyester fabrics for the disperse dyes can be met; a dyeing and finishing process flow of a polyester-cotton blended fabric and a polyester fabric is simplified, requirements of energy saving and emission reduction in the textile industry are met, and good social and economic benefits can be obtained.

Unless otherwise specified, solvents of solutions in the examples are all water.

What is claimed is:

1. A method for preparing benzisothiazole disperse dyes different in alkali resistance, comprising: achieving a difference in alkali resistance by adjusting groups of a structural formula of the benzisothiazole disperse dyes; and obtaining an alkali resistance sequence of the disperse dyes after different groups are introduced,
wherein the structural formula of the benzisothiazole disperse dyes is shown in Formula 1: 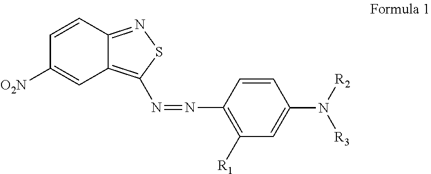
and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; and alkyl groups involved are all C1-4 alkyl groups;
on the basis that R₁ is hydrogen, methyl, ethyl, methoxy or ethoxy and R₂ is linear or branched alkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl>the alkali resistance of a benzisothiazole disperse dye obtained when R₃ is cyanoalkyl, cyanoalkoxyalkyl or hydroxyalkyl; and
on the basis that R₁ is hydrogen, methyl, ethyl, methoxy or ethoxy and R₂ is cyanoalkyl or cyanoalkoxyalkyl, the alkali resistance of a benzisothiazole disperse dye obtained when R₃ is benzyl, phenyl, alkylphenyl or alkylbenzyl>the alkali resistance of a benzisothiazole disperse dye obtained when R₃ is alkyl.

2. The method according to claim 1, wherein on the basis that R₁ is hydrogen, methyl or ethyl and R₂ is linear or branched alkyl, the alkali resistance of a benzisothiazole disperse dye obtained when R₃ is benzyl or alkylbenzyl>the alkali resistance of a benzisothiazole disperse dye obtained when R₃ is alkyl>the alkali resistance of a benzisothiazole disperse dye obtained when R₃ is cyanoalkyl, cyanoalkoxyalkyl or hydroxyalkyl; and
on the basis that R₁ is hydrogen, methyl or ethyl and R₂ is cyanoalkyl or cyanoalkoxyalkyl, the alkali resistance of a benzisothiazole disperse dye obtained when R₃ is benzyl or alkylbenzyl>the alkali resistance of a benzisothiazole disperse dye obtained when R₃ is alkyl.

3. The method according to claim 1, wherein a synthetic method of a benzisothiazole disperse dye comprises the following steps:
(1) performing a diazo reaction: adding 3-amino-5-nitrobenzisothiazole into a reaction vessel, adding concentrated H₂SO₄, reducing a temperature to 0-5° C., adding nitrosyl sulfuric acid under stirring, performing uniform stirring and detection with a starch-potassium iodide test paper until the color is blue to ensure that nitrosyl sulfuric acid is excessive, performing a reaction continuously for 2-5 h, adding sulfamic acid to remove excessive nitrosyl sulfuric acid after the reaction is completed, and performing stirring to obtain a diazo solution;
(2) performing a coupling reaction: adding water, H₂SO₄ and a coupling component into a reaction vessel, performing stirring, and reducing the temperature to 0-10° C. for a reaction to obtain a coupling solution; slowly adding the diazo solution obtained in step (1) dropwise into the coupling solution under stirring for performing a reaction continuously at 0-10° C. for 1-3 h, increasing the temperature to 0-15° C. for performing a reaction continuously for 4-5 h, and after the reaction is completed, adding sodium hydroxide to adjust the pH to neutral to obtain a product; performing suction filtration, washing and drying on the obtained product to obtain a filter cake;
(3) dissolving the filter cake obtained in step (2) in an ethanol solution, and performing reflux, cooling, recrystallization, filtration and drying to obtain a benzisothiazole disperse dye.

4. The method according to claim 3, wherein the method further comprises adjusting an N substituent in the coupling component to achieve a difference in alkali resistance, and the alkali resistance of a benzisothiazole disperse dye obtained when the N substituent in the coupling component is p-methylbenzyl or benzyl>the alkali resistance of a benzisothiazole disperse dye obtained when the N substituent in the coupling component is benzyl+cyano or benzyl+cyanoethoxyethyl>the alkali resistance of a benzisothiazole disperse dye obtained when the N substituent in the coupling component is ethyl>the alkali resistance of a benzisothiazole disperse dye obtained when the N substituent in the coupling component is cyanoethyl, cyanoethoxyethyl or hydroxyethyl.

5. A method for preparing benzisothiazole disperse dyes different in oxidation resistance when pH=10, comprising: achieving a difference in oxidation resistance by adjusting groups of a structural formula of the benzisothiazole disperse dyes; and obtaining an oxidation resistance sequence of the disperse dyes after different groups are introduced,
wherein the structural formula of the benzisothiazole disperse dyes is shown in Formula 1: 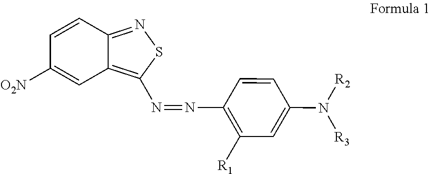
and in Formula 1, R₁ is hydrogen, methyl, ethyl, methoxy or ethoxy; R₂ and R₃ are each independently linear or branched alkyl, hydroxyalkyl, cyanoalkyl, cyanoalkoxyalkyl, phenyl, benzyl, alkylphenyl or alkylbenzyl; and alkyl groups involved are all C1-4 alkyl groups;
on the basis that R₁ is hydrogen, methyl, ethyl, methoxy or ethoxy and R₂ is linear or branched alkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is cyanoalkyl, cyanoalkoxyalkyl or hydroxyalkyl; and
on the basis that R₁ is hydrogen, methyl, ethyl, methoxy or ethoxy and R₂ is cyanoalkyl or cyanoalkoxyalkyl, the oxidation resistance of a benzisothiazole disperse dye obtained when R₃ is benzyl, phenyl, alkylphenyl or alkylbenzyl>the oxidation resistance of a benzisothiazole disperse dye obtained when R₃ is alkyl.

6. The method according to claim 5, wherein on the basis that R₁ is hydrogen, methyl or ethyl and R₂ is linear or branched alkyl, the oxidation resistance of a benzisothiazole disperse dye obtained when R₃ is benzyl, alkylbenzyl or alkyl>the oxidation resistance of a benzisothiazole disperse dye obtained when R₃ is cyanoalkyl, cyanoalkoxyalkyl or hydroxyalkyl; and
on the basis that R₁ is hydrogen, methyl or ethyl and R₂ is cyanoalkyl or cyanoalkoxyalkyl, the oxidation resistance of a benzisothiazole disperse dye obtained when R₃ is benzyl or alkylbenzyl>the oxidation resistance of a benzisothiazole disperse dye obtained when R₃ is alkyl.

7. The method according to claim 5, wherein a synthetic method of a benzisothiazole disperse dye comprises the following steps:
(1) performing a diazo reaction: adding 3-amino-5-nitrobenzisothiazole into a reaction vessel, adding concentrated H₂SO₄, reducing a temperature to 0-5° C., adding nitrosyl sulfuric acid under stirring, performing uniform stirring and detection with a starch-potassium iodide test paper until the color is blue to ensure that nitrosyl sulfuric acid is excessive, performing a reaction continuously for 2-5 h, adding sulfamic acid to remove excessive nitrosyl sulfuric acid after the reaction is completed, and performing stirring to obtain a diazo solution;
(2) performing a coupling reaction: adding water, H₂SO₄ and a coupling component into a reaction vessel, performing stirring, and reducing the temperature to 0-10° C. for a reaction to obtain a coupling solution; slowly adding the diazo solution obtained in step (1) dropwise into the coupling solution under stirring for performing a reaction continuously at 0-10° C. for 1-3 h, increasing the temperature to 0-15° C. for performing a reaction continuously for 4-5 h, and after the reaction is completed, adding sodium hydroxide to adjust the pH to neutral to obtain a product; performing suction filtration, washing and drying on the obtained product to obtain a filter cake;
(3) dissolving the filter cake obtained in step (2) in an ethanol solution, and performing reflux, cooling, recrystallization, filtration and drying to obtain a benzisothiazole disperse dye.

8. The method according to claim 7, wherein the method further comprises adjusting an N substituent in the coupling component to achieve a difference in oxidation resistance, and the oxidation resistance of a benzisothiazole disperse dye obtained when the N substituent in the coupling component is p-methylbenzyl, benzyl, ethyl, benzyl+cyano or benzyl+cyanoethoxyethyl is higher than that of a benzisothiazole disperse dye obtained when the N substituent in the coupling component is cyanoethyl, cyanoethoxyethyl or hydroxyethyl.

9. A benzisothiazole disperse dye, having the following structural formula: [chemical structure]
